(19) United States
(12) Patent Application Publication
(10) Pub. No.: US 2026/0247331 A1
(43) Pub. Date: Aug. 20, 2026

(54) DEVICE POSITIONING METHOD AND DEVICE POSITIONING SYSTEM OF MESH NETWORK

(71) Applicant: WNC Corporation, Hsinchu (TW)

(72) Inventors: Ming-Shien LU, Hsinchu (TW); Chia-Yi LIEN, Hsinchu (TW)

(21) Appl. No.: 19/430,395

(22) Filed: Dec. 23, 2025

(30) Foreign Application Priority Data
Feb. 19, 2025 (TW) 114106125

(51) Int. Cl. H04W 64/00; H04L 41/12; H04W 84/18

(52) U.S. Cl. CPC H04W 64/00; H04L 41/12; H04W 84/18

(57) ABSTRACT

A device positioning method of a mesh network includes transmitting a topology query packet to a plurality of extended access points and a root access point in the mesh network; returning a plurality of topology response packets to the root access point according to the topology query packet; collecting a plurality of customized forwarding databases and a plurality of interface access addresses corresponding to the extended access points and the root access point from the topology response packets; obtaining a wireless client address based on the topology response packets, thereby determining that one of a plurality of access addresses other than the wireless client address and the interface access addresses is an Ethernet client address; and searching for the Ethernet client address from the topology response packets corresponding to the extended access points and the root access point.

### RELATED APPLICATIONS

This application claims the benefit of priority to Taiwan Patent Application No. 114106125, filed on Feb. 19, 2025. The entire content of the above identified application is incorporated herein by reference.

### BACKGROUND

### Technical Field

The present disclosure relates to a device positioning method and a device positioning system, in particular to a device positioning method and device positioning system of a mesh network.

### Description of Related Art

Nowadays, wireless networks (Wi-Fi) and Ethernet have become the main communication technologies used for internet access. A mesh network is a type of network that transmits data and control commands among network nodes through dynamic routing. A mesh network may include multiple Access Points (APs) and multiple clients, wherein the access points may be interconnected via wireless networks or wired Ethernet connections. Clients can be classified into wireless clients and Ethernet clients, which respectively refer to devices connecting to access points through Wi-Fi interfaces and Ethernet interfaces. Access points can be categorized into Root Access Points (Root APs) and Extender Access Points (Extender APs).

The EasyMesh standard published by the Wi-Fi Alliance defines a Topology Query Message, a Topology Response Message, and a Topology Notification Message. However, the information defined in the EasyMesh standard only considers wireless clients and does not account for Ethernet clients. Because these messages do not provide information about which access point an Ethernet client is connected to within a mesh network, a complete topology map of the mesh network cannot be constructed. This results in a complex and cumbersome network troubleshooting process and makes it difficult to understand the connection relationships between Ethernet clients and access points. Therefore, there is currently a lack of a positioning method and system for Ethernet clients in the market, and relevant industry players are seeking solutions.

### SUMMARY

One aspect of the present disclosure is to provide a device positioning method of a mesh network. The method includes a plurality of steps of: transmitting, by a controller of a root access point, a topology query packet within the mesh network to a plurality of extended access points and an agent of the root access point, wherein the mesh network includes an Ethernet client device; returning, by the extended access points and the agent, a plurality of topology response packets to the controller based on the topology query packet; collecting, by the controller, a plurality of customized forwarding databases and a plurality of interface access addresses respectively corresponding to the extended access points and the agent from the topology response packets, wherein the customized forwarding databases include a plurality of access addresses; identifying, by the controller, a wireless client address among the access addresses based on the topology response packets, and determining one of the access addresses, excluding the wireless client address and the interface access addresses, as an Ethernet client address of the Ethernet client device; and searching, by the controller, the topology response packets corresponding to the extended access points and the agent for the Ethernet client address to determine whether the Ethernet client device is connected to one of the extended access points and the root access point.

Another aspect of the present disclosure is to provide a device positioning system of a mesh network. The system includes a root access point and a plurality of extended access points. The root access point includes a controller and an agent. The controller is configured to transmit a topology query packet within the mesh network, wherein the mesh network includes an Ethernet client device. The agent is connected to the controller and configured to receive the topology query packet. The extended access points are coupled to the root access point and configured to receive the topology query packet. The extended access points and the agent return a plurality of topology response packets to the controller based on the topology query packet. The controller collects a plurality of customized forwarding databases and a plurality of interface access addresses respectively corresponding to the extended access points and the agent from the topology response packets. The customized forwarding databases include a plurality of access addresses. The controller identifies a wireless client address among the access addresses based on the topology response packets, and determines one of the access addresses, excluding the wireless client address and the interface access addresses, as an Ethernet client address of the Ethernet client device. The controller searches the topology response packets corresponding to the extended access points and the agent for the Ethernet client address to determine whether the Ethernet client device is connected to one of the extended access points and the root access point.

### BRIEF DESCRIPTION OF THE DRAWINGS

The present disclosure can be more fully understood by reading the following detailed description of the embodiment, with reference made to the accompanying drawings as follows:

FIG. 1 is a flowchart illustrating a device positioning method of a mesh network according to a first embodiment of the present disclosure.

FIG. 2 is a schematic diagram of a mesh network in some embodiments of the present disclosure.

FIG. 3 is a schematic diagram illustrating the steps of transmitting a topology query packet and returning a plurality of topology response packets shown in FIG. 1.

FIG. 4 is a flowchart illustrating the step of searching for an Ethernet client address to determine whether the Ethernet client device is connected to one of the plurality of extended access points and the root access point shown in FIG. 1.

FIG. 5 is a block diagram illustrating a device positioning system of a mesh network according to a second embodiment of the present disclosure.

### DETAILED DESCRIPTION

The present disclosure is more particularly described in the following embodiments that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an” and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second,” and “third” can be used to describe various components, signals or the like, which are for distinguishing one component/signal from another one only, and are not intended to, nor should be construed to impose any substantive limitations on the components, signals or the like.

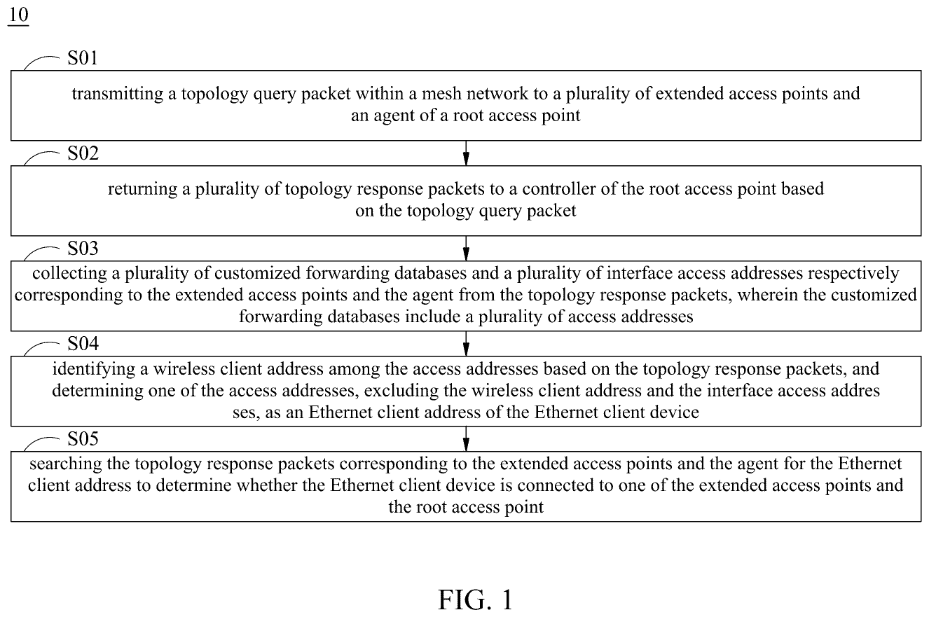

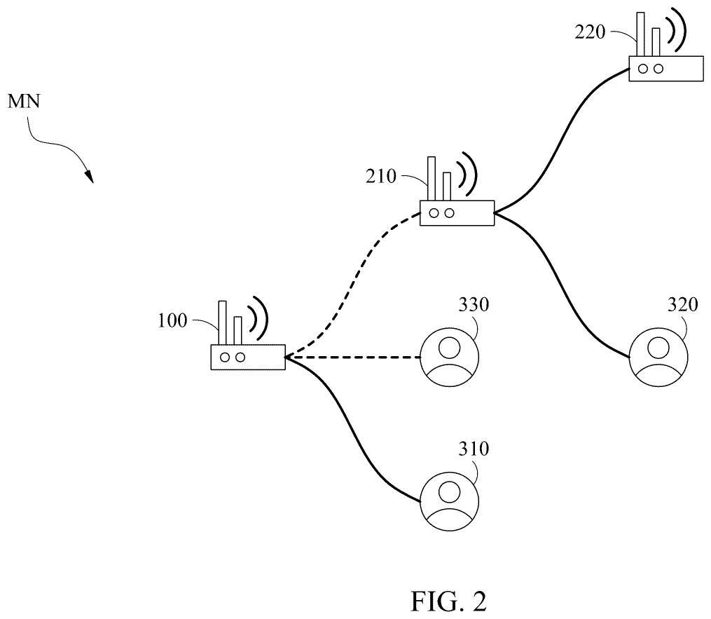

Please refer to FIG. 1 and FIG. 2 together. FIG. 1 is a flowchart illustrating a device positioning method 10 of a mesh network according to a first embodiment of the present disclosure. FIG. 2 is a schematic diagram of a mesh network MN in some embodiments of the present disclosure. As shown in FIGS. 1 and 2, the device positioning method 10 of the mesh network (hereinafter, referred to as “the device positioning method 10”) can be configured to locate at least one client device in the mesh network MN. In this embodiment, the mesh network MN includes three access points and three client devices. The three access points may be a root access point 100 and extended access points 210, 220, and the three client devices may be Ethernet client devices 310, 320, and a wireless client device 330. However, the present disclosure is not limited to the number of access points and client devices shown in FIG. 2. The device positioning method 10 includes the following steps: S01, S02, S03, S04, and S05.
Step S01 involves transmitting, by a controller of the root access point 100, a topology query packet within the mesh network MN to the extended access points 210, 220 and an agent of the root access point 100.
Step S02 involves returning, by the extended access points 210, 220 and the agent of the root access point 100, a plurality of topology response packets to the controller of the root access point 100 based on the topology query packet.
Step S03 involves collecting, by the controller of the root access point 100, a plurality of customized forwarding databases and a plurality of interface access addresses respectively corresponding to the extended access points 210, 220 and the agent from the topology response packets, wherein the customized forwarding databases include a plurality of access addresses.
Step S04 involves identifying, by the controller, a wireless client address among the access addresses based on the topology response packets, and determining one of the access addresses, excluding the wireless client address and the interface access addresses, as an Ethernet client address of an Ethernet client device (i.e., the Ethernet client device 310 or the Ethernet client device 320).
Step S05 involves searching, by the controller, the topology response packets corresponding to the extended access points 210, 220 and the agent for the Ethernet client address to determine whether the Ethernet client device (i.e., the Ethernet client device 310 or the Ethernet client device 320) is connected to one of the extended access points 210, 220 and the root access point 100.

Thus, the device positioning method 10 of the present disclosure analyzes the information carried in the topology response packets to identify Ethernet client addresses, and then searches each topology response packet returned from the access points for the Ethernet client addresses, thereby determining to which access point the Ethernet client devices 310, 320 are respectively connected, achieving accurate positioning.

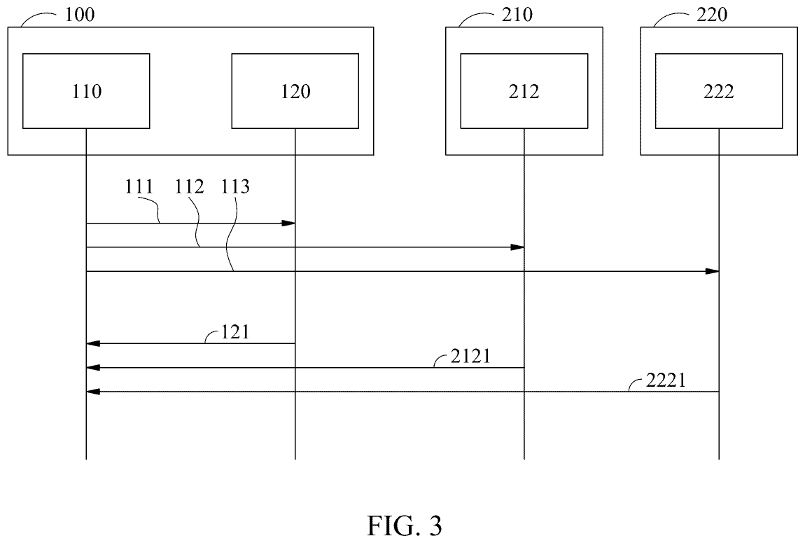

Please continue referring to FIG. 3, which is a schematic diagram illustrating Step S01 of transmitting the topology query packet and Step S02 of returning the topology response packets as shown in FIG. 1. In some embodiments, the mesh network MN may adopt a Controller-Agent-Client network architecture, which includes a controller and a plurality of agents and is configured to provide network services to one or more clients. As shown in FIG. 3, the root access point 100 may include a controller 110 and an agent 120, and the extended access points 210, 220 may respectively include agents 212 and 222.

In Step S01, the topology query packet may include a plurality of packets 111, 112, 113. The controller 110 of the root access point 100 unicasts the topology query packets 111, 112, 113 respectively to all downstream agents (i.e., agents 120, 212, 222). The packets 111, 112, 113 may be Topology Query Messages as defined by the IEEE 1905.1 standard or vendor specific query messages related to the IEEE 1905.1 standard; however, the present disclosure is not limited thereto. In Step S02, upon receiving the topology query packets 111, 112, 113, the agents 120, 212, 222 respectively unicast a plurality of topology response packets 121, 2121, 2221 to the controller 110. The topology response packets 121, 2121, 2221 may be Topology Response Messages defined in the IEEE 1905.1 standard or vendor specific response messages related to the IEEE 1905.1 standard; however, the present disclosure is not limited thereto.

In some embodiments, Step S02 may include receiving, by each of the extended access points 210, 220 and the agent 120, the topology query packet via a respective upstream backhaul port, and establishing a bridging forwarding database, that is, Step S02 may include that the agents 120, 212, 222 receive the topology query packets 111, 112, 113 via their respective upstream backhaul ports, and then establish corresponding bridging forwarding databases. Taking the root access point 100 as an example, the agent 120 may use bridge management commands in the Linux system (e.g., brctl showmacs) to examine the Media Access Control (MAC) addresses connected to the Local Area Network (LAN), thereby establishing a bridging forwarding database. Please refer to Table 1, which provides an example of a bridging forwarding database established by the agent 120. The bridging forwarding database may include MAC addresses corresponding to different ports, indications of whether they are local addresses, and their associated contact times. However, the present disclosure is not limited thereto.

TABLE 1
bridging forwarding database established by the agent 120

| | | whether they | |
|---|---|---|---|
| | | are local | contact |
| port | MAC addresses | addresses | times (s) |
| 6 | 20:cd:6e:da:04:b5 | NO | 0.91 |
| 9 | 58:96:71:7b:64:f3 | YES | 0.00 |
| 11 | 58:96:71:7b:66:c0 | NO | 2.12 |
| 11 | 58:96:71:7b:67:f0 | NO | 2.51 |
| 5 | 5a:96:71:7b:65:f8 | YES | 0.00 |
| 8 | 5a:96:71:7b:65:f9 | YES | 0.00 |
| 7 | 5a:96:71:7b:66:f5 | YES | 0.00 |
| 6 | 5a:96:71:7b:66:f6 | YES | 0.00 |
| 10 | 5a:96:71:7b:67:f4 | YES | 0.00 |
| 3 | 68:05:ca:5f:fb:fc | NO | 0.75 |
| 11 | d8:c4:97:d6:39:9c | NO | 0.23 |

In some embodiments, the agents 212, 222 of the extended access points 210, 220, and the agent 120 of the root access point 100, may each learn at least one first access address via their respective upstream backhaul ports, and then delete the learned first access address from the bridging forwarding database. The aforementioned first access address refers to a MAC address in the bridging forwarding database established by the agents 120, 212, 222 that originates from an upstream device, not from a downstream device. However, as shown in the embodiment of FIG. 2, the upstream backhaul port of the root access point 100 is not actually connected to any other upstream device or network node. Therefore, the bridging forwarding database in Table 1 will not list any first access address, and thus the agent 120 does not need to perform deletion of learned first access addresses.

In some embodiments, Step S02 may further include that each of the agents 120, 212, 222 deletes at least one second access address associated with a contact time greater than a threshold time from the bridging forwarding database, so that the plurality of bridging forwarding databases are regenerated as customized forwarding databases; and the agents 120, 212, 222 respectively insert the customized forwarding databases into the topology response packets 121, 2121, 2221, and return the topology response packets 121, 2121, 2221 to the controller 110. Specifically, the agent 120 will ignore the second access addresses in Table 1 with contact times exceeding the threshold (e.g., 60 seconds) so as to regenerate the bridging forwarding database into a customized forwarding database. The purpose of ignoring the second access addresses is to avoid having client devices that are already offline but still remain in the topology map. Finally, the agent 120 can include the customized forwarding database in topology response packet 121 and return it to controller 110. As shown in Table 1, because the agent 120 has no MAC addresses learned from the upstream backhaul port (i.e., no first access address), and no MAC address has a contact time exceeding the threshold (i.e., no second access address), the customized forwarding database included in topology response packet 121 returned to controller 110 is equivalent to the bridging forwarding database in Table 1.

Taking the extended access point 210 as an example, the agent 212 may also use bridge management commands in the Linux system to check the Media Access Control (MAC) addresses connected to the local area network, thereby establishing a bridging forwarding database. Please refer to Table 2, which provides an example of a bridging forwarding database established by the agent 212 of the extended access point 210. However, the present disclosure is not limited thereto.

TABLE 2
bridging forwarding database established by the agent 212

| | | whether they | |
|---|---|---|---|
| | | are local | contact |
| port | MAC addresses | addresses | times (s) |
| 11 | 20:cd:6e:da:04:b5 | NO | 1.35 |
| 11 | 58:96:71:7b:64:f0 | NO | 0.08 |
| 8 | 58:96:71:7b:66:c1 | YES | 0.00 |
| 9 | 58:96:71:7b:66:c3 | YES | 0.00 |
| 11 | 58:96:71:7b:66:c7 | YES | 0.00 |
| 1 | 58:96:71:7b:67:f0 | NO | 62.05 |
| 5 | 5a:96:71:7b:67:c8 | YES | 0.00 |
| 6 | 5a:96:71:7b:67:c9 | YES | 0.00 |
| 7 | 5a:96:71:7b:68:c5 | YES | 0.00 |
| 12 | 5a:96:71:7b:68:c6 | YES | 0.00 |
| 10 | 5a:96:71:7b:69:c4 | YES | 0.00 |
| 11 | 68:05:ca:5f:fb:fc | NO | 2.79 |
| 3 | d8:c4:97:d6:39:9c | NO | 0.08 |

As previously described, the agent 212 learns at least one first access address through its own upstream backhaul port and deletes the learned first access address from the bridging forwarding database, as well as deletes second access addresses whose contact times exceed the threshold time. It should be noted that each of the agents 212, 222 of the extended access points 210, 220, and the agent 120 of the root access point 100, may include multiple ports. The agent 212 determines which of its ports is the upstream backhaul port based on topology query packet 112—by detecting which port receives the topology query packet 112, the port can be directly identified as the upstream backhaul port. The same logic applies to the agents 120, 222.

For example, the agent 212 detects, based on the source of the topology query packet 112, that the current upstream backhaul port is port (11), and deletes from the bridging forwarding database the first access addresses learned from port (11). In addition, as shown in Table 2, the contact time for port (1) is 62.05 seconds, which exceeds the threshold time (60 seconds). Therefore, the agent 212 also deletes the entry with the 62.05-second contact time from the second access addresses corresponding to port (1) in the bridging forwarding database. Consequently, the customized forwarding database included in the topology response packet 2121 returned by the agent 212 to controller 110 is shown in Table 3 below.

TABLE 3
customized forwarding database established by the agent 212

| | | whether they | |
|---|---|---|---|
| | | are local | contact |
| port | MAC addresses | addresses | times (s) |
| 8 | 58:96:71:7b:66:c1 | YES | 0.00 |
| 9 | 58:96:71:7b:66:c3 | YES | 0.00 |
| 5 | 5a:96:71:7b:67:c8 | YES | 0.00 |
| 6 | 5a:96:71:7b:67:c9 | YES | 0.00 |
| 7 | 5a:96:71:7b:68:c5 | YES | 0.00 |
| 12 | 5a:96:71:7b:68:c6 | YES | 0.00 |
| 10 | 5a:96:71:7b:69:c4 | YES | 0.00 |
| 3 | d8:04:97:d6:39:9c | NO | 0.08 |

Taking the extended access point 220 as an example, please refer to Table 4, which provides an example of a bridging forwarding database established by the agent 222 of the extended access point 220. However, the present disclosure is not limited thereto.

TABLE 4
bridging forwarding database established by the agent 222

| | | whether they | |
|---|---|---|---|
| | | are local | contact |
| port | MAC addresses | addresses | times (s) |
| 1 | 20:cd:6e:da:04:b5 | NO | 2.07 |
| 1 | 58:96:71:7b:64:f0 | NO | 0.34 |
| 1 | 58:96:71:7b:66:c0 | NO | 9.48 |
| 8 | 58:96:71:7b:67:f1 | YES | 0.00 |
| 9 | 58:96:71:7b:67:f3 | YES | 0.00 |
| 5 | 5a:96:71:7b:68:15 | YES | 0.00 |
| 11 | 5a:96:71:7b:68:f6 | YES | 0.00 |
| 7 | 5a:96:71:7b:69:f8 | YES | 0.00 |
| 6 | 5a:96:71:7b:69:f9 | YES | 0.00 |
| 10 | 5a:96:71:7b:6a:f4 | YES | 0.00 |
| 1 | 68:05:ca:5f:fb:fc | NO | 1.47 |
| 1 | d8:c4:97:d6:39:9c | NO | 0.87 |

For the extended access point 220, the agent 222 detects, based on the source of the topology query packet 113, that the current upstream backhaul port is port (1), and deletes from the bridging forwarding database the first access addresses learned from port (1). In addition, as shown in Table 4, the contact times of all ports are less than the threshold time. Therefore, the customized forwarding database included in the topology response packet 2221 returned by agent 222 to controller 110 is shown in Table 5 below.

TABLE 5
customized forwarding database established by the agent 222

| | | whether they | |
|---|---|---|---|
| | | are local | contact |
| port | MAC addresses | addresses | times (s) |
| 8 | 58:96:71:7b:67:f1 | YES | 0.00 |
| 9 | 58:96:71:7b:67:f3 | YES | 0.00 |
| 5 | 5a:96:71:7b:68:f5 | YES | 0.00 |
| 11 | 5a:96:71:7b:68:f6 | YES | 0.00 |
| 7 | 5a:96:71:7b:69:f8 | YES | 0.00 |
| 6 | 5a:96:71:7b:69:f9 | YES | 0.00 |
| 10 | 5a:96:71:7b:6a:f4 | YES | 0.00 |

In Step S03, after receiving the topology response packets 121, 2121, 2221, the controller 110 can obtain not only the multiple access addresses listed in the MAC address fields of Tables 1, 3, and 5, but also collect the interface access addresses corresponding to the root access point 100 and the extended access points 210, 220. Specifically, taking the root access point 100 as an example, the agent 120 includes a port address table in the topology response packet 121. Therefore, the controller 110 can extract this port address table from the topology response packet 121 to collect the interface access addresses associated with root access point 100. The collection method for the interface access addresses of extended access points 210, 220 is similar. Furthermore, in the MAC address fields of Tables 1, 3, and 5, controller 110 can identify the Organizationally Unique Identifier (OUI) of each MAC address. Among them, access addresses with OUIs “58:96:71” and “5a:96:71” represent the interface access addresses corresponding to the root access point 100 and the extended access points 210, 220.

In the EasyMesh standard, the controller 110 can determine that one of the access addresses obtained from the topology response packets 121, 2121, 2221 is a wireless client address. In addition, Step S04 may include that controller 110 determines, based on the wireless client address, that the wireless client device 330 is connected to one of the extended access points 210, 220 and the root access point 100. Specifically, in the topology map of the mesh network MN, the downstream of the root access point 100 may be connected via a wireless network (Wi-Fi) to the extended access point 210 and wireless client device 330, respectively, while the downstream of the extended access point 210 may be electrically connected to the extended access point 220 via Ethernet. The connection relationships among access points and client devices can be obtained through the topology response packets 121, 2121, 2221 to enable the controller 110 to locate the wireless client device 330. In some embodiments, the controller 110 may also receive a plurality of topology notification packets (not illustrated) from the agents 120, 212, 222, wherein the topology notification packets may be one type of Topology Notification Message defined in the EasyMesh standard, and each topology notification packet can also carry the wireless client addresses associated with its respective access point.

Accordingly, the device positioning method 10 of the present disclosure can determine, based on the topology response packets 121, 2121, 2221 or the topology notification packets, that the wireless client device 330 is located the downstream of the root access point 100. It can also determine, from the topology response packets 121, 2121, 2221, which access addresses have been learned by each access point. In this way, the controller 110 can exclude the wireless client device 330 and the interface access addresses corresponding to each access point from the collected access addresses, and treat the remaining access addresses as the Ethernet client addresses of the Ethernet client devices 310, 320. The following provides an example using the device positioning method 10 to locate the Ethernet client device 310 shown in FIG. 2, wherein the Ethernet client address of the Ethernet client device 310 is “68:05:ca:5f:fb:fc”.

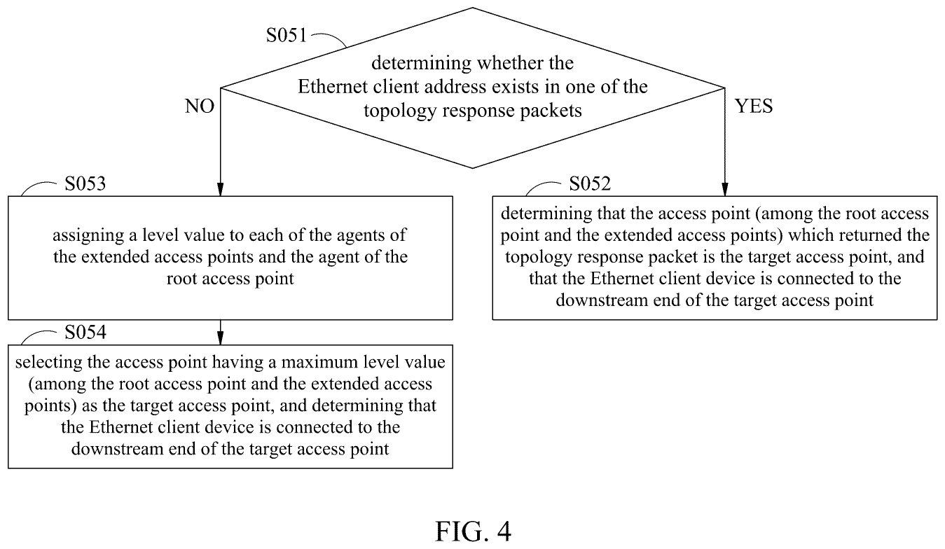

Please continue referring to FIG. 4, which is a flowchart illustrating Step S05 of searching for the Ethernet client address to determine whether the Ethernet client devices 310, 320 is connected to one of the extended access points 210, 220 and the root access point 100. In some embodiments, Step S05 may include Steps S051, S052, S053, S054.

Step S051 involves determining, by the controller 110, whether the Ethernet client address “68:05:ca:5f:fb:fc” exists in one of the topology response packets 121, 2121, or 2221 to generate a determination result. In other words, in Step S051, the controller 110 first checks whether the Ethernet client address “68:05:ca:5f:fb:fc” is recorded in only one of the three customized forwarding databases returned by the agents 120, 212, 222. If the determination result is affirmative (i.e., “YES”), Step S052 is executed. Step S052 involves determining, by controller 110, that the access point (among the root access point 100 and the extended access points 210, 220) which returned the topology response packet is the target access point, and that the Ethernet client device 310 is connected to the downstream end of the target access point. Conversely, if the determination result is negative (i.e., “NO”), Steps S053, S054 are executed sequentially. Step S053 involves assigning, by controller 110, a level value to each of the agents 212, 222 of the extended access points 210, 220 and the agent 120 of the root access point 100. Step S054 involves selecting, by controller 110, the access point having a maximum level value (among the root access point 100 and the extended access points 210, 220) as the target access point, and determining that the Ethernet client device 310 is connected to the downstream end of that target access point. As shown in Tables 1, 3, and 5, the controller 110 finds the Ethernet client address “68:05:ca:5f:fb:fc” only in the topology response packet 121 returned by the agent 120 of root access point 100. Therefore, the controller 110 determines that Ethernet client device 310 is electrically connected to the downstream end of the root access point 100.

On the other hand, the Ethernet client address of Ethernet client device 320 is “d8:c4:97:d6:39:9c”. As shown in Tables 1, 3, and 5, the controller 110 finds the Ethernet client address “d8:c4:97:d6:39:9c” in both the topology response packets 121, 2121 returned by the agents 120, 212 of the root access point 100 and the extended access point 210, respectively. This means the determination result is “NO”, indicating that both the root access point 100 and the extended access point 210 have learned the Ethernet client address of the Ethernet client device 320. The controller 110 must then further determine whether the Ethernet client device 320 is connected to the downstream end of root access point 100 or extended access point 210.

In some embodiments, Step S053 may include that the controller 110 assigns an initial level value (e.g., 1) to the agent 120 of the root access point 100, and then increments the initial value by 1 for each time a backhaul interface is passed, thereby setting a plurality of the level values for the extended access points 210, 220 located at the downstream end of the root access point 100. Specifically, the backhaul interface may include either an Ethernet backhaul or a wireless backhaul (i.e., a Wi-Fi backhaul), meaning that starting from the downstream end of the root access point 100, each Ethernet backhaul or Wi-Fi backhaul link traversed increases the level value by 1. Therefore, the controller 110 may assign level values of 2 and 3 to the extended access points 210, 220, respectively. In Step S054, since the level value for the root access point 100 is 1 and that for the extended access point 210 is 2, the controller 110 selects the extended access point 210, which has the maximum level value, as the target access point, and determines that the Ethernet client device 320 is connected to the downstream end of the extended access point 210.

Thus, the device positioning method 10 of the present disclosure can utilize topology response messages defined in the IEEE 1905.1 standard or vendor specific messages related to the IEEE 1905.1 standard to carry information regarding access points and client devices, thereby enabling accurate positioning of the Ethernet client devices 310, 320. This facilitates the debugging of the mesh network MN environment and reduces maintenance time and costs.

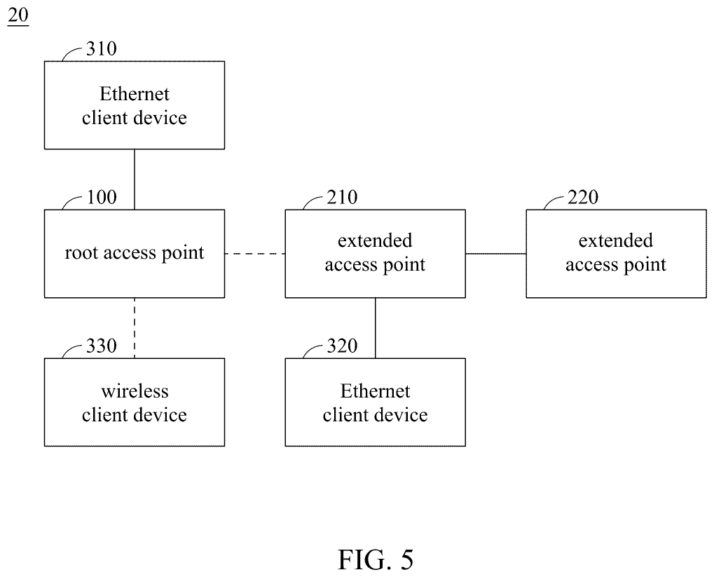

Please also refer to FIGS. 1, 2, 3, and 5, wherein FIG. 5 is a block diagram illustrating a device positioning system 20 of a mesh network according to a second embodiment of the present disclosure. As shown in FIGS. 1, 2, 3, and 5, the device positioning system 20 of the mesh network is configured to implement the device positioning method 10 and locate the extended access points 210, 220, the Ethernet client devices 310, 320, and the wireless client device 330.

The device positioning system 20 of the mesh network includes the root access point 100 and the extended access points 210, 220. The root access point 100 includes the controller 110 and the agent 120. The controller 110 is configured to transmit the topology query packets 111, 112, 113 within the mesh network MN. The agent 120 is connected to the controller 110 and receives the topology query packet 111. The extended access points 210, 220 are coupled to the root access point 100 and respectively receive the topology query packets 112, 113. The agent 120 of the root access point 100 and the agents 212, 222 of the extended access points 210, 220, respectively, return the topology response packets 121, 2121, 2221 to the controller 110 based on the topology query packets 111, 112, 113. In addition, the controller 110 may also receive a plurality of topology notification packets (not illustrated) from the agents 120, 212, 222, respectively.

Thus, the controller 110 can collect the interface access addresses of each access point through the topology response packets 121, 2121, 2221, and determine from the topology response packets 121, 2121, 2221 or topology notification packets that the wireless client device 330 is connected to the root access point 100. In addition, the controller 110 can collect multiple access addresses from the customized forwarding databases in the topology response packets 121, 2121, 2221, and identify those access addresses—excluding the wireless client address and interface access addresses—as Ethernet client addresses. Then, by executing the device positioning method 10, it can be determined that the Ethernet client device 310 is connected to the root access point 100, and the Ethernet client device 320 is connected to extended access point 210.

In summary, the device positioning method and device positioning system for the mesh network disclosed herein offer the following advantages: First, they help accurately locate the Ethernet client device. Second, by ignoring access addresses with a contact time exceeding a threshold time, they assist in resolving the issue of wireless client devices and Ethernet client devices lingering in the topology diagram. Third, by assigning level values, they enable fast and precise identification of which access point's downstream end the Ethernet client device is located at.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A device positioning method of a mesh network, comprising a plurality of steps of:
transmitting, by a controller of a root access point, a topology query packet within the mesh network to a plurality of extended access points and an agent of the root access point, wherein the mesh network comprises an Ethernet client device;
returning, by the extended access points and the agent, a plurality of topology response packets to the controller based on the topology query packet;
collecting, by the controller, a plurality of customized forwarding databases and a plurality of interface access addresses respectively corresponding to the extended access points and the agent from the topology response packets, wherein the customized forwarding databases comprise a plurality of access addresses;
identifying, by the controller, a wireless client address among the access addresses based on the topology response packets, and determining one of the access addresses, excluding the wireless client address and the interface access addresses, as an Ethernet client address of the Ethernet client device; and
searching, by the controller, the topology response packets corresponding to the extended access points and the agent for the Ethernet client address to determine whether the Ethernet client device is connected to one of the extended access points and the root access point.

2. The device positioning method of the mesh network according to claim 1, wherein the step of returning the topology response packets to the controller based on the topology query packet comprises:
receiving, by each of the extended access points and the agent, the topology query packet via a respective upstream backhaul port, and establishing a bridging forwarding database.

3. The device positioning method of the mesh network according to claim 2, wherein each of the extended access points learns at least one first access address via the respective upstream backhaul port, and deletes the at least one first access address from the bridging forwarding database.

4. The device positioning method of the mesh network according to claim 2, wherein each of the extended access points and the agent learns at least one first access address via the respective upstream backhaul port and deletes the at least one first access address from the bridging forwarding database.

5. The device positioning method of the mesh network according to claim 2, wherein each of the extended access points and the agent comprises a plurality of ports, and determines one of the ports as the respective upstream backhaul port according to the topology query packet.

6. The device positioning method of the mesh network according to claim 2, wherein the step of returning the topology response packets to the controller based on the topology query packet further comprises:
deleting, by each of the extended access points and the agent, at least one second access address associated with a contact time greater than a threshold time from the bridging forwarding database, so that a plurality of the bridging forwarding databases are regenerated as the customized forwarding databases; and
inserting, by the extended access points and the agent respectively, the customized forwarding databases into the topology response packets, and returning the topology response packets to the controller.

7. The device positioning method of the mesh network according to claim 1, wherein the mesh network further comprises a wireless client device, and the step of identifying the wireless client address among the access addresses based on the topology response packets comprises:
determining, by the controller, whether the wireless client device is connected to the one or another of the extended access points and the root access point according to the wireless client address;
wherein the controller receives a topology notification packet from each of the extended access points and the agent so as to identify the wireless client address among the access addresses based on a plurality of the topology notification packets.

8. The device positioning method of the mesh network according to claim 1, wherein the step of searching the topology response packets corresponding to the extended access points and the agent for the Ethernet client address comprises:
determining, by the controller, whether the Ethernet client address exists in one of the topology response packets to generate a determination result;
wherein, when the determination result is affirmative, the controller determines the one of the extended access points and the root access point that returned the one of the topology response packets as a target access point, and determines that the Ethernet client device is connected to a downstream end of the target access point;
wherein, when the determination result is negative, the controller assigns a level value to each of the extended access points and the agent, selects the one having a maximum level value among the extended access points and the root access point as the target access point, and determines that the Ethernet client device is connected to the downstream end of the target access point.

9. The device positioning method of the mesh network according to claim 8, wherein the step of assigning the level value to each of the extended access points and the agent comprises:
setting, by the controller, an initial value as the level value assigned to the agent, and incrementing the initial value by 1 for each time a backhaul interface is passed, thereby setting a plurality of the level values for the extended access points.

10. The device positioning method of the mesh network according to claim 9, wherein the backhaul interface comprises either an Ethernet backhaul or a wireless backhaul.

11. A device positioning system of a mesh network, comprising:
a root access point, comprising:
a controller, configured to transmit a topology query packet within the mesh network, wherein the mesh network comprises an Ethernet client device; and
an agent, connected to the controller and configured to receive the topology query packet; and
a plurality of extended access points, coupled to the root access point and configured to receive the topology query packet;
wherein the extended access points and the agent return a plurality of topology response packets to the controller based on the topology query packet, the controller collects a plurality of customized forwarding databases and a plurality of interface access addresses respectively corresponding to the extended access points and the agent from the topology response packets, and the customized forwarding databases comprise a plurality of access addresses;
wherein the controller identifies a wireless client address among the access addresses based on the topology response packets, and determines one of the access addresses, excluding the wireless client address and the interface access addresses, as an Ethernet client address of the Ethernet client device;
wherein the controller searches the topology response packets corresponding to the extended access points and the agent for the Ethernet client address to determine whether the Ethernet client device is connected to one of the extended access points and the root access point.

12. The device positioning system of the mesh network according to claim 11, wherein each of the extended access points and the agent receives the topology query packet via a respective upstream backhaul port, and then establishes a bridging forwarding database.

13. The device positioning system of the mesh network according to claim 12, wherein each of the extended access points learns at least one first access address via the respective upstream backhaul port, and deletes the at least one first access address from the bridging forwarding database.

14. The device positioning system of the mesh network according to claim 12, wherein each of the extended access points and the agent learns at least one first access address via the respective upstream backhaul port, and deletes the at least one first access address from the bridging forwarding database.

15. The device positioning system of the mesh network according to claim 12, wherein each of the extended access points and the agent comprises a plurality of ports, and determines one of the ports as the respective upstream backhaul port based on the topology query packet.

16. The device positioning system of the mesh network according to claim 12, wherein:
each of the extended access points and the agent deletes at least one second access address associated with a contact time greater than a threshold time from the bridging forwarding database, so that a plurality of the bridging forwarding databases are regenerated as the customized forwarding databases; and
the extended access points and the agent respectively insert the customized forwarding databases into the topology response packets and return the topology response packets to the controller.

17. The device positioning system of the mesh network according to claim 11, wherein the mesh network further comprises a wireless client device, the controller determines, according to the wireless client address, whether the wireless client device is connected to the one or another of the extended access points and the root access point.

18. The device positioning system of the mesh network according to claim 11, wherein the controller determines whether the Ethernet client address exists in one of the topology response packets to generate a determination result;
wherein, when the determination result is affirmative, the controller determines the one of the extended access points and the root access point that returned the one of the topology response packets as a target access point, and determines that the Ethernet client device is connected to a downstream end of the target access point;
wherein, when the determination result is negative, the controller assigns a level value to each of the extended access points and the agent, selects the one having a maximum level value among the extended access points and the root access point as the target access point, and determines that the Ethernet client device is connected to the downstream end of the target access point.

19. The device positioning system of the mesh network according to claim 18, wherein the controller sets the level value assigned to the agent as an initial value, and increments the initial value by 1 for each time a backhaul interface passed, thereby setting a plurality of the level values for the extended access points.

20. The device positioning system of the mesh network according to claim 19, wherein the backhaul interface comprises either an Ethernet backhaul or a wireless backhaul.
